(19) United States
(12) Patent Application Publication
(10) Pub. No.: US 2005/0245265 A1
(43) Pub. Date: Nov. 3, 2005

(54) Optimisation mechanism for frequency reuse

(75) Inventors: Andrea Nascimbene, Torres D'Lsola (IT); Aldo Bolle, Vastra Frolunda (SE)

Correspondence Address: NIXON & VANDERHYE, PC, 901 NORTH GLEBE ROAD, 11TH FLOOR, ARLINGTON, VA, 22203, US

(73) Assignee: Telefonaktiebolaget LM Ericsson (publ), Stockholm (SE)

(21) Appl. No.: 10/525,645

(22) PCT Filed: Sep. 15, 2003
(86) PCT No.: PCT/SE03/01431

§ 371 Date: Feb. 25, 2005

Related U.S. Application Data
(60) Provisional application No. 60/410,265, filed on Sep. 13, 2002.

(51) Int. Cl. H04Q 7/20

(52) U.S. Cl. 455/447; 455/446

(57) ABSTRACT

The present invention describes a network planning mechanism for the optimisation of system quality associated with frequency reuse for a mobile network infrastructure and business access applications, by using an intelligent combination of microwave point-to-point and point-to-multipoint links in Broadband Wireless Access Systems or LMDS, for example. In an embodiment of the invention, Radio Base Stations (RBSs) sites can be connected to the Switch site by a combination of fibre optics, leased lines, or preferably microwave radio links. The embodiment enables traffic from several end sites to be concentrated at selected hub sites (hub site 1-4). The system is optimised by minimizing the quality degradation that can be experienced due to excessive interference inside a certain portion of the point-to-multipoint covered sector by means of the combined point-to-multipoint and point-to point solutions. The RBS, which on the planning phase will experience excessive interference in the direction to the hub, is not directly connected the point-to-multipoint hub, but through a point-to-point link connecting to an access terminal, co-located with a different RBS or business user, in line of sight with the previous one. The access terminal in turn connects the point-to-multipoint hub allowing a frequency reuse factor of one to be deployed.

### FIELD OF THE INVENTION

The present invention pertains generally to mobile telecommunication networks and, more specifically, to the optimisation of the system quality associated with frequency reuse.

### BACKGROUND OF THE INVENTION

In a basic mobile telecommunication network, a mobile switching center (MSC) is linked to a plurality of base transceiver stations by digital transmission links. In GSM, for example, the digital transmission links connect the radio base stations (RBS) to a base station controller (BSC), which controls and manages the base stations and converges the traffic to the MSC. The transmission of voice and data traffic between the base stations and the core network is a vital task and is often referred to as backhaul. Typically, mobile operators employ either leased lines (T1/E1), privately owned wire lines (including fibre optic lines), or microwave links for backhaul operations. However, using leased T1 or E1 lines generally involves leasing them from a fixed telephone provider that requires paying what can be expensive monthly charges to someone who can be a direct competitor. Alternatively, operators can use their own wire lines, but this is often unattractive due to the high cost of installation from digging and laying the lines of building the infrastructure. Another disadvantage is that the relatively slow deployment of installing lines and the inflexibility for expansion becomes an important limitation in industries experiencing fast growth such as mobile communications.

A more attractive option is to provide backhaul using microwave radio e.g. point-to-point links whereby a base station is connected to the BSC via line-of-sight mounted microwave antennas that are in direct communication with each other. Another variation used is that of the point-to-multipoint link that connects various base stations to a single BSC location, for example. The growth of mobile networks and 3 G networks carrying increasing amounts of packet/cell traffic will lead to an increase in demand for more capacity and flexibility in the backhaul part of these networks. Microwave links are capable of carrying relatively large amounts of data, comparable to E1/T1 trunks, enable operators to offer a plethora of new high bit-rate services. The cost effectiveness of microwave links also allows mobile operators to combine cellular backhaul with business access within the same sector to enable a wide range of professional services, allowing quick access to market and fast growth of business.

The expansion in services including voice and video as well as new packet switched applications, provide new opportunities for operators to attract new customers. However, a primary concern to operators is to provide customers with high network quality and reliable quality of service (QoS) to customer terminals. Factors that lower network quality include spectrum efficiency and excessive interference, which can be attributed to inefficient traffic resource allocation and high frequency reuse factor in cells.

In view of the foregoing, it is desirable to provide an improved network planning mechanism for optimising system quality and frequency reuse in mobile network infrastructures for ensuring reliability and quality of service in high bit-rate services such as business access applications.

### SUMMARY OF THE INVENTION

Briefly described and in accordance with embodiments and related features thereof, there is provided a method and system for a network planning mechanism for the optimisation of system quality associated with frequency reuse for a mobile network infrastructure and business access applications, by using an intelligent combination of microwave point-to-point and point-to-multipoint links in Broadband Wireless Access Systems or LMDS, for example. In an embodiment of the invention, Radio Base Stations (RBSs) sites can be connected to the Switch site by a combination of fibre optic lines, leased lines, or preferably microwave links. The embodiment enables traffic from several end sites to be concentrated at selected hub sites. By way of example, the network planning of the point-to-point and point-to-multipoint links can be chosen to enable a first RBS site to be connected to a second RBS site by means of a point-to-point terminal such that the access terminal, co-located with the second RBS site, routes the traffic from both the first RBS site and the second RBS site to the Hub site. This enables the traffic of the first RBS site to be much less affected by co-channel interference from a remote point-to-multipoint Hub site.

In a system aspect of the invention, the system is optimised by minimizing the quality degradation that can be experienced due to excessive interference inside a certain portion of the point-to-multipoint covered sector by means of a combined point-to-multipoint and point-to point link solution. The RBS in the planning phase that experiences excessive interference in the direction to the hub, is not directly connected the point-to-multipoint hub, but through a point-to-point link connecting to an access terminal, co-located with a different RBS (or business user), in line of sight with the previous one. The access terminal in turn connects the point-to-multipoint hub allowing a frequency reuse factor of one to be deployed. The point-to-point link uses a portion of the point-to-multipoint frequency block consisting of a single wideband channel, without using a dedicated frequency, thus allowing the safe use of a frequency reuse factor of one that results in significantly reduced interference.

### BRIEF DESCRIPTION OF THE DRAWINGS

The invention, together with further objectives and advantages thereof, may best be understood by reference to the following description taken in conjunction with the accompanying drawings in which:

FIG. 1 is a depiction of an exemplary access network;

FIG. 2 shows the cell patterns resulting from using a frequency reuse factor of one and two respectively;

FIG. 3 shows the overall CIR patterns for reuse factors of one and two respectively;

FIG. 4 shows the CIR patterns for the worst sector;

FIG. 5 shows the combined use of point-to-multipoint and point-to-point links that allows for the safe use of a frequency reuse factor of one; and

FIG. 6 shows the point-to-point link contained within the point-to-multipoint frequency spectrum.

### DETAILED DESCRIPTION OF THE INVENTION

1. Scope

In an embodiment of the present invention there is provided a mechanism for the optimisation of the frequency reuse, for mobile network infrastructure and business access applications, by means of combined use of microwave point-to-point links and point-to-multipoint, Broadband Wireless Access Systems or Local Multipoint Distribution Systems (LMDS), for example. Deployment of LMDS is particularly attractive since LMDS networks can be rolled out very quickly, offering customers service in a matter of days and weeks, compared with the relatively long time to deploy fibre networks, for example.

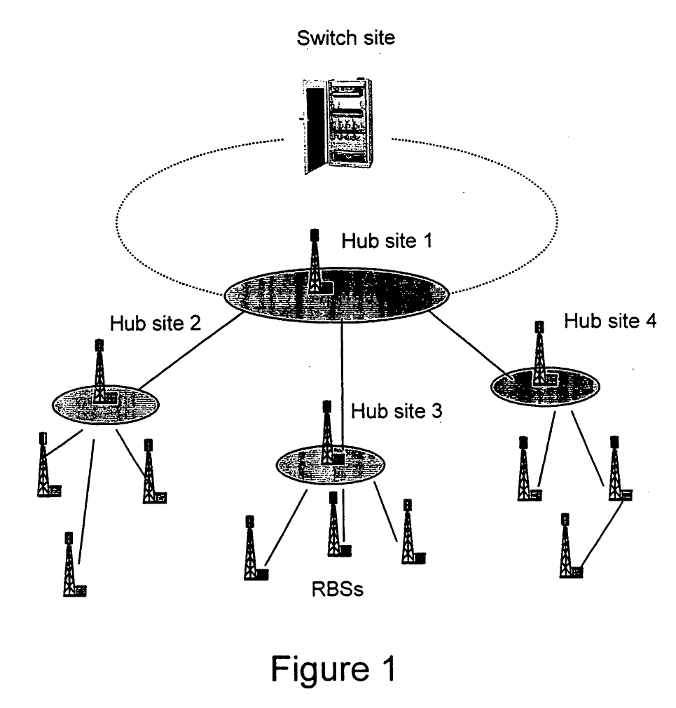

FIG. 1 shows an example of the access network for a mobile network application. The end Radio Base Stations (RBSs) can be connected to the Switch site by a combination of fibre optics, leased lines or microwave links. This last technology has been the preferred one both for economical and speed of deployment reasons. Furthermore, FIG. 1 shows how traffic from several end sites can be concentrated at selected hub sites (hub site 1-4). In the figure, a site where traffic is concentrated is called a hub site. The Business Access application can still be described by the FIG. 1 by simply replacing the RBSs with business users. The present invention illustrates how an intelligent combination of the microwave point-to-point and point-to-multipoint technologies can strongly improve the spectrum efficiency in comparison with exclusive use of point-to-multipoint or point-to-point deployment.

2. Use of Point-to-multipoint Systems in the Mobile Infrastructure and Business Access

The main benefits in using point-to-multipoint systems in mobile infrastructure and business access applications are roll out flexibility, traffic aggregation with optimum traffic resource allocation, and port aggregation, as described in the forgoing sections.

A point-to-multipoint systems based on Asynchronous Transfer Mode (ATM) and on a TDMA access scheme with Fast Dynamic Capacity Allocation (F-DCA), gives several advantages compared to point-to-point links or leased lines. ATM as a packet transport technology, optimised for telecom needs, provides guaranteed Quality of Service (QoS) and the ability to carry any real-time and non real-time traffic. The net benefit of using ATM to accommodate fluctuating capacity demands is that the network can be ‘oversubscribed’ in terms of number of registered users while still offering QoS, leading to cost savings for the operator. Furthermore, ATM provides differentiated priorities, quality parameters and tariffs among different services and users and can support both IP and legacy services.

Fast Dynamic Capacity Allocation (F-DCA) is the key to allocating the capacity in a point-to-multipoint system on an ATM cell basis. The benefit of F-DCA is the ability to share capacity over the sector with full flexibility. An example of an LDMS solution is Ericsson's MINI-LINK BAS™ which is a broadband wireless access system using point-to-multipoint microwave with the capability of dedicated or dynamically allocating capacity between base stations for high bandwidth services such as high-speed Internet, VPN, LAN-LAN interconnection and videoconferencing.

The roll out flexibility when deploying a point-to multipoint system comes from the area coverage inherently provided by the system. Traffic aggregation benefits come in terms of granularity gain and in terms of potential traffic overbooking. Finally, the built-in ATM concentrator in a point-to-multipoint system allows for cost efficient port aggregation at a hub site or at the switch site.

Point-to-multipoint microwave transmission requires a minimum density of base stations or business users to be economically competitive. As a simple rule of thumb, point-to-multipoint systems become an interesting option when four to five radio base stations or business users can be connected to the central point-to-multipoint hub. While point-to-multipoint has clear advantages over point-to-point in dense areas, the two technologies will continue to be used in combination. Point-to-point microwave is typically deployed in less base station-dense areas and in combination with point-to-multipoint when distance or interference requires it.

The following definitions and terms used herein apply:
point-to-multipoint—microwave system topology scheme consisting of a single hubbing equipment connecting several access terminals through a particular media and by using a particular multiple access scheme.
point-to-multipoint hub—equipment interfacing one or more Access Terminals through a radio connection. It normally consists of (but may be not limited to) at least one radio unit with antenna and modem. It is located at a hub site.
AT—Access Terminal—terminal device used to connect remote sites to the hub site via a radio connection towards a point-to-multipoint hub.
point-to-point—microwave system topology scheme consisting of a single link connecting two points.
point-to-point terminal—terminal device required at the two ends of a point-topoint link.
   3. Problem Description

Point-to-multipoint systems are deployed in cellular structure and the frequency reuse is fundamental for successful deployment. Note that all terminals in one sector, i.e. all access terminals connected to the same point-to-multipoint hub, use the same frequency, as typical for broadband point-to-multipoint system with a TDMA access scheme.

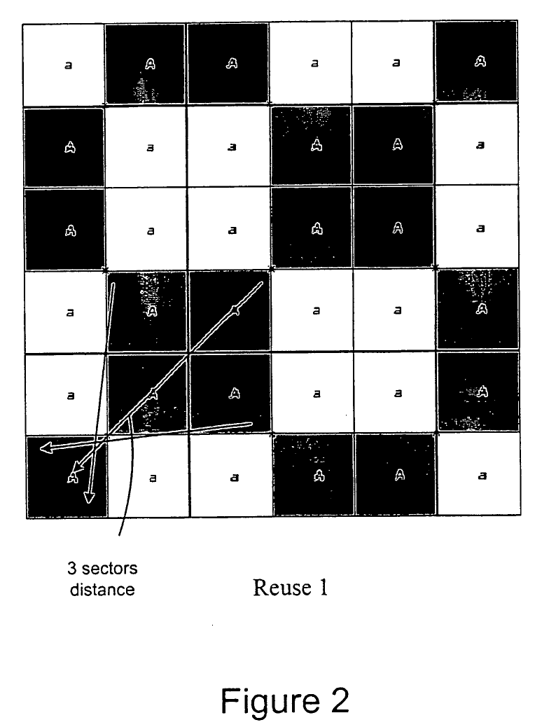

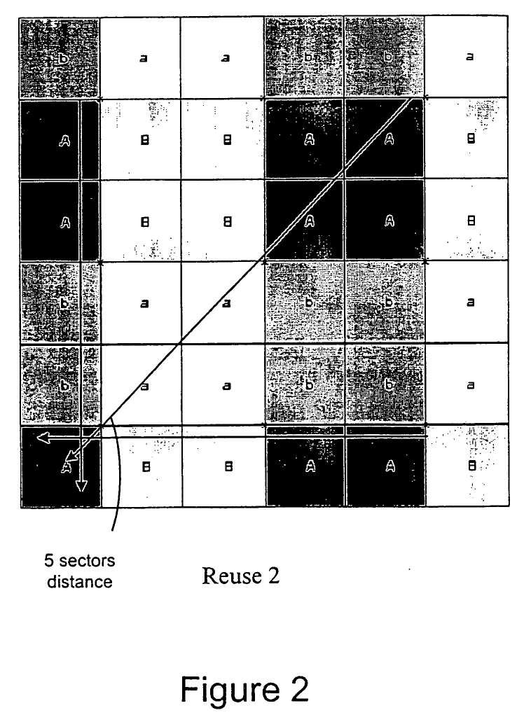

Referring now to FIG. 2, the reuse factor can be defined as the ratio between the number of channels available to the operator and the number of channels usable in the same sector. The lower reuse factor, the better spectrum efficiency is achieved. In the following a deployment with reuse factor of 1 and 2 are compared. By way of example, suppose we need to cover a particular area by a 3×3 Hub sites with a point-to-multipoint system. The cell patterns with reuse of 2 and 1 are shown in FIG. 2 (the stars indicate the hub locations). The “reuse 2” pattern shown uses two frequencies (A/B) and two polarizations (a/b) while the “reuse 1” pattern shown uses one frequency and two polarizations (a/A).

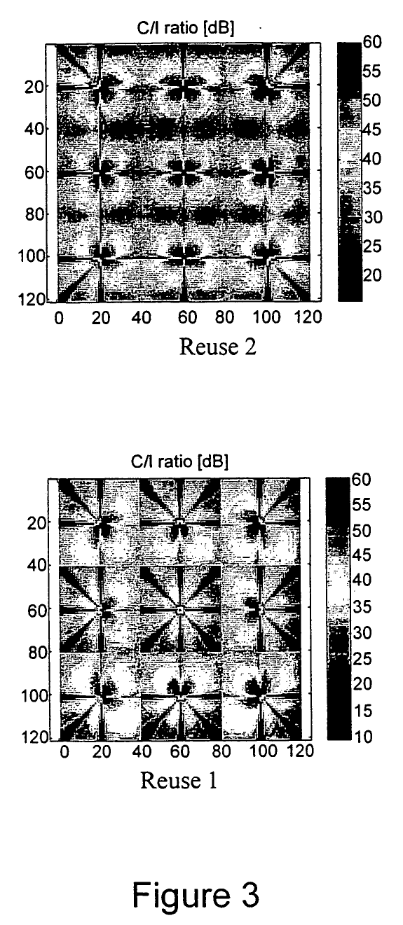

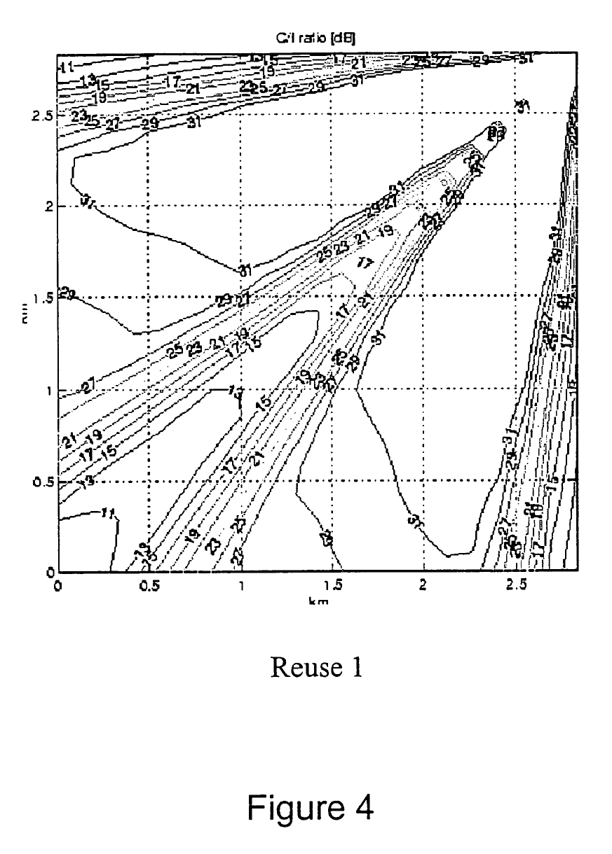

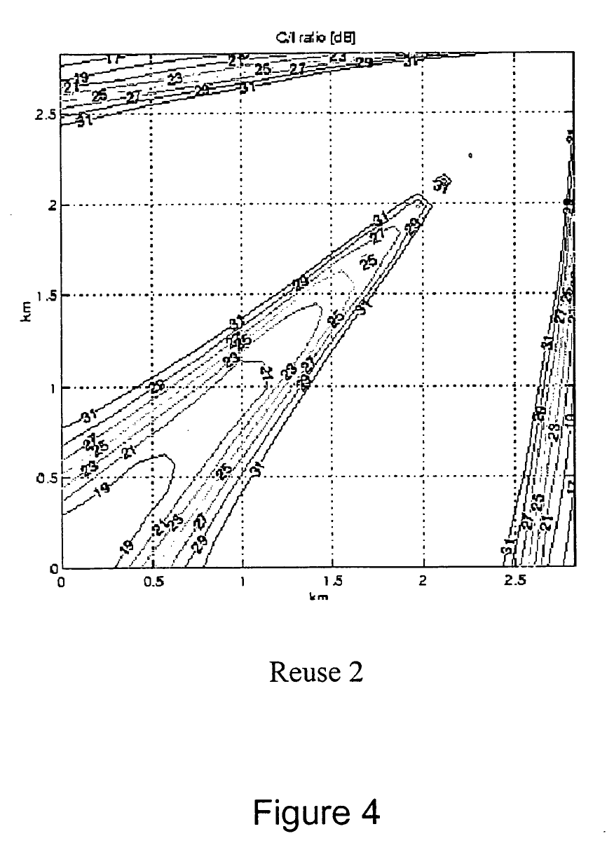

Referring now to FIG. 3, the cell patterns, assuming free line of sight over the whole area, generate the CIR (Carrier to Interference Ratio) patterns shown in FIG. 3, over the whole area, and in FIG. 4, over the worst sector. In order to limit receiver degradation and achieve error free operation of the system, the CIR (or C/I) has to exceed a value, which depends on the used modulation scheme.

It can be concluded that the point-to-multipoint cellular deployment is such that certain portion of the area inside the covered sector, mainly along the side and the diagonal of the square sector, can experience excessive interference due to a co-channel/co-polarized remote hub. This portion is higher when the reuse factor is lower.

The point-to-multipoint cellular deployment is such that a few locations inside the covered sector can experience excessive interference due to a co-channel/co-polarised remote hub. This can be avoided by means of a higher frequency reuse (e.g. 2 or more). Hence the choice is between spectrum efficiency and network quality.

The embodiment of the invention contemplates a network planning mechanism that simultaneously allows the best spectrum efficiency and the best quality. To achieve best spectrum efficiency, the point to multipoint system is planned for a frequency reuse of one. To avoid network quality degradation point-to-point links are used in the planning phase, either a point-to-multipoint or a point-to-point terminal is chosen as a function of the C/I value in each location, for example.

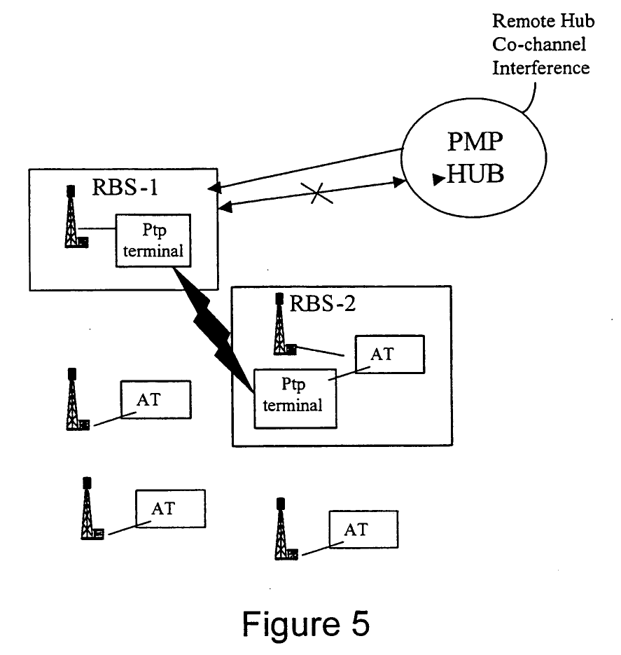

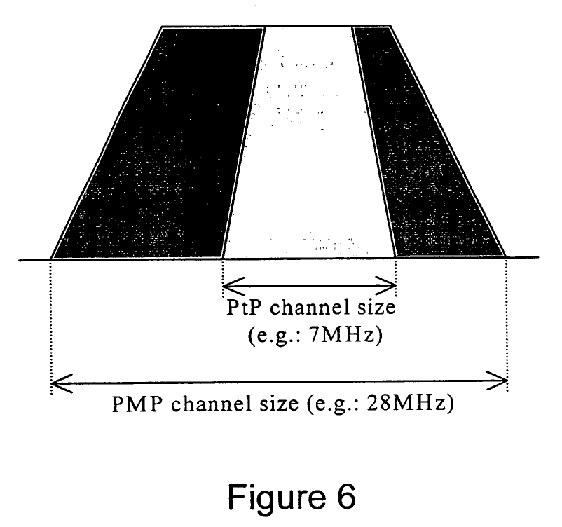

FIG. 5 illustrates an RBS-1, if connected to the local hub through an Access Terminal (AT), would be affected by the co-channel interference from a remote point-to-multipoint hub. When RBS-1 is instead connected to RBS-2 by means of a point-to-point terminal, the antenna angular discrimination will improve the C/I value and guarantee the network quality. Finally the AT, co-located with the RBS-2, will route to the hub both the RBS-1 and -2 traffic. It should be noted that the point-to-point link can reuse part of the point-to-multipoint spectrum (e.g. 7 MHz inside the 28 MHz point-to-multipoint frequency block allocation), allowing for a very spectrum efficient solution, as shown in FIG. 6. Also note that the FIG. 5 exemplifies the mobile infrastructure application but the RBSs can be replaced by business users with no modifications of the concept as described.

The invention contemplates the combined use of the point-to-multipoint and point-to-point solutions of the embodiment enables the use of a single frequency block, equal to the point-to-multipoint system channel size, to be sufficient for the complete access network deployment (excluding possible links among hubs) and provides a large improvement in terms of spectrum efficiency. The system quality is optimized in each covered sector of a multi-site cellular deployment by means of the combined use of point-to-multipoint and point-to-point links with minimum spectrum usage such that the total required frequency block equals the channel size of the point-to-multipoint, Broadband Wireless Access Systems or LMDS. Furthermore, the spectrum usage is minimized by means of the angular antenna discrimination in conjunction with the traffic route diversity.

The improvement lies in the fact that the RBS or business user, which on the planning phase would experience excessive interference in the direction to the hub, is not directly connected the point-to-multipoint hub but through a point-to-point link connecting to an access terminal (AT), co-located with a different RBS or business user, in the line of sight with the previous one. The AT in turn connects the point-to-multipoint hub. The point-to point link does not use any dedicated frequency but a portion of the point-to-multipoint frequency block consisting of a single wideband channel (reuse of 1). The interference is cut and the network quality is preserved due exclusively to the angular protection of the highly directional antenna of the point-to-point terminal, with very little spectrum waste.

Although the invention has been described in some respects with reference to specified embodiments thereof, variations and modifications will become apparent to those skilled in the art. It is therefore the intention that the following claims not be given a restrictive interpretation but should be viewed to encompass variations and modifications that are derived from the inventive subject matter disclosed.

1. A method of network planning for a mobile network infrastructure comprising a switch site connected to a plurality of Hub sites that are connected to a plurality of radio base stations (RBSs) sites, wherein the mobile network is arranged to provide wireless data and voice services to access terminals in a way that the overall system quality is improved by improving the frequency reuse for said mobile network infrastructure characterized by, connecting the Hub sites to the RBS using combination of point-to-point links and point-to-multipoint links.

2. A method according to claim 1 wherein the point-to-multipoint link is a microwave link and is deployed with a frequency reuse of one requiring use of only a single wideband channel.

3. A method according to claim 1 wherein the point-to-point link is a microwave link and uses a portion of the point-to-multipoint frequency block consisting of a single wideband channel, without using a dedicated frequency, thus having a reuse of one.

4. A method according to claim 2 wherein the interference within a portion of the point-to-multipoint covered sector is reduced by choosing either a point-to-multipoint or a point-to-point terminal as a function of the C/I value in each location, thereby improving spectrum efficiency an the system quality.

5. A method according to claim 1 wherein the network planning includes a first RBS site is connected to a second RBS site by means of a point-to-point terminal such that the access terminal, co-located with the second RBS site, routes the traffic from both the first RBS site and the second RBS site to the Hub site such that the first RBS site is less affected by co-channel interference.

6. A method according to claim 5 wherein the spectrum usage is minimized by means of the angular antenna discrimination in conjunction with the traffic route diversity.

7. A method according to claim 1 wherein the RBSs are replaced by business users receiving and running high bit-rate Business Access applications.

8. A mobile network comprising a switch site connected to a plurality of Hub sites that are connected to a plurality of radio base stations (RBSs) sites, wherein the mobile network is arranged to provide wireless data and voice services to access terminals such that service quality is improved and interference reduced characterized in that, the Hub sites are connected to the RBS sites using combination of point-to-point links and point-to-multipoint links.

9. A mobile network according to claim 8 wherein the point-to-point links and point-to-multipoint links are any one of radio microwave links, fibre optic lines, or copper lines.

10. A mobile network according to claim 8 wherein the point-to-point link to the terminals are achieved by use of radio antennas having high angular discrimination for reducing the interference.

11. A mobile network according to claim 8 wherein a first RBS site is connected to a second RBS site by means of a point-to-point terminal such that the access terminal, co-located with the second RBS site, routes the traffic from both the first RBS site and the second RBS site to the Hub site such that the first RBS site is less affected by co-channel interference.

12. A mobile network according to claim 8 wherein the point-to-point link is a microwave link and uses a portion of the point-to-multipoint frequency block consisting of a single wideband channel, without using a dedicated frequency, thus having a reuse of one.

13. A mobile network according to claim 8 wherein the RBSs can be replaced by business users receiving and running high bit-rate Business Access applications.
